(19) United States
(12) Patent Application Publication
(10) Pub. No.: US 2012/0266976 A1
(43) Pub. Date: Oct. 25, 2012

(54) Automated System for Low Pressure Fluid Recovery

(75) Inventor: Mark Goodyear, Lafayette, LA (US)

(73) Assignee: ENERMAX, INC., Lafayette, LA (US)

(21) Appl. No.: 13/386,520

(22) PCT Filed: Apr. 21, 2011
(86) PCT No.: PCT/US11/33365

§ 371 Date: Jan. 23, 2012

(51) Int. Cl. F16K 31/12

(52) U.S. Cl. 137/488

(57) ABSTRACT

An automated low pressure fluid recovery system is disclosed. An eductor receives low pressure fluid from a source, for example vapors from a hydrocarbon tank. The eductor also receives high pressure fluid from another source, for example the output of a compressor or a well. By venturi principles the two fluid streams are mixed and a third intermediate fluid stream is formed, which is routed to a desired location. The low pressure fluids are thereby beneficially captured and sold or otherwise used. Various sensing devices, such as pressure and temperature sensors, emit signals to a programmable logic controller, which in turn automatically manipulates various control mechanisms to efficiently and safely control fluid flow through the system.

### CROSS REFERENCE TO RELATED APPLICATIONS

Not applicable.

### BACKGROUND

1. Field of the Invention

This invention is related to apparatus and method for recovery of various low pressure fluids, particularly but not limited to hydrocarbon fluids (gases and/or liquids) generated in conjunction with the production of oil and gas. More particularly, the invention relates to an automated system for recovery and reintroduction into a desired location, such as a sales stream of such fluids, which may be otherwise discharged into the atmosphere, where essential operating parameters of the various components of the system are operated in their most efficient and safe manner, thereby maximizing recovery of the low pressure fluids.

2. Related Art

In conjunction with various industrial processes, including but not limited to the production of oil and gas, from both onshore and offshore facilities, significant volumes of low pressure hydrocarbon fluids and other vapors are generated. By way of example only, such hydrocarbon fluids, namely vapors, flow off of volumes of oil which are held in atmospheric storage tanks. Other examples include tanks holding produced salt water, which may have some natural gas entrained therein. Whatever the source, these low pressure fluids, which may be vapors at certain combinations of pressure and temperature, and liquids at other pressure/temperature conditions, cumulate to quite large volumes of hydrocarbons and other emissions.

Problems arise in the handling and disposition of such low pressure hydrocarbons. Two key issues include: (1) the loss of economic value, in that these hydrocarbons represent quite valuable hydrocarbon fuels, if they can be economically captured and placed into a sales stream; and (2) the pollution of the atmosphere by discharge of the hydrocarbons into the atmosphere.

It can be readily understood that the cumulative economic value of these hydrocarbon fluids is quite significant, when emissions from hundreds if not thousands of production facilities is considered. Significant economic motive therefore exists to capture these emissions, particularly hydrocarbons, and sell same.

Of equally significant importance is prevention of carbon emissions into the atmosphere. It is well known that carbon emissions are a huge issue, and reduction of same carries significant economic worth (directly and indirectly). Not only hydrocarbons but other pollutants are put into the atmosphere from these emissions.

Prior art handling of emissions has included venting such fluids, namely gases or vapors, into the atmosphere, resulting in a complete loss of the value of the gases, in addition to significant pollution. Prior art handling has also included flaring (burning) of the gases, obviously creating many other issues associated with combustion of the hydrocarbons. Again, flaring or burning results in a complete loss of fluids.

The prior art includes various methods for capturing low pressure fluids, including vapors, with the use of eductors. As an example, U.S. Pat. Nos. 6,315,000 and 6,418,957, also invented by the inventor of the present invention and commonly owned with the present invention, disclose an eductor system and method for vapor recovery. These patents include a general discussion of the operation of eductors. In short, eductor recovery systems use an eductor, also referred to as a “jet pump,” operating on the principle of a venturi, through which an energized (relatively higher pressure) fluid is directed causing a differential pressure across an orifice situated in a mixing chamber. The mixing chamber has a port to allow fluids or gases at a relatively lower pressure (lower than the energizing fluid pressure) to be drawn into the chamber due to the created differential between the higher pressure line and the lower pressure lines. The lower pressure fluids or gases being drawn into the chamber mix with the energized fluid or gases resulting in a mixture of both fluids and or gases at some intermediate pressure.

The system of these two patents U.S. Pat. No. 6,315,000 and U.S. Pat. No. 6,418,957 represented a significant improvement in the relevant art. However, certain limitations remained, primarily related to operating efficiency and safety aspects.

Operating efficiency of the system can be increased by control of flow rates and pressures of the high pressure, low pressure, and intermediate pressure fluid streams, by valving, controls, etc. Safety aspects, both as to personnel safety and protection of equipment, can also be increased by the inclusion and operation of “shut down” devices, which may stop operation of the system if pressures get too high or too low, if temperatures get too high, or if abnormal flow conditions are detected. It can be appreciated that systems that rely on manually operated controls alone, or those that use a minimum of or lower-level automated controls, may not yield the desired level of efficient operation.

### SUMMARY OF THE INVENTION

The present invention comprises an automated eductor-based low pressure fluid or emission recovery system. The system includes one or more eductors to collect, contain and recycle emissions generally exhausted or otherwise emitted into the atmosphere in a manner resulting in a closed loop system. The low pressure fluid recovery system disclosed herein may be directed to the recovery of vapors emitted from hydrocarbon production processes, and the reintroduction of such vapors into a usable fluid system (whether for sale or re-use in some beneficial manner), and not to eductor type units used for vapor recovery used in external fuel tank vapor recovery for fuel distribution or fuel blending systems and the like. Other applications are possible and contemplated within the scope of the invention.

The system comprises one or more eductors or jet pump operating on the venturi principle as a core element. The system further includes flow safety valves, flow measuring elements, flow control mechanisms and shutdowns, pressure sensing devices and shutdowns, and temperature sensing and indicating devices. In addition, an automated system, typically using one or more digital processors, receives data from various sensing devices, and automatically controls various aspects (flow, pressure, etc.) of the system in order to maximize operating efficiency and safety. The invention contemplates different levels or degrees of automation to suit the needs of a particular production system.

In a first level system, a processor relay control center module may receive commands from a device such as a touch screen device. A power supply, which may comprise one or a combination of sources such as shore side or generator power, battery/inverter power, and/or solar or wind generator power, supplies electrical power to the processor relay control center module. A communication modem permits radio, cellular, and/or satellite communications with the processor relay control center module. The processor relay control center module receives signals from various devices, such as pressure safety low and pressure safety high indicators and temperature switches. The processor relay control center module signals an output control module, which controls devices such as alarms, shut-down valves, pressure control valves, and pumps.

A second or intermediate level system adds an input module which receives signals from devices such as pressure safety low and high sensors, one or more pressure transmitters, and one or more temperature transmitters, then sends appropriate signals to a programmable logic controller, namely a microprocessor or computer, which replaces the processor relay control center module of the first level system. An additional or alternative communication modem is provided, which may comprise an ethernet connection. One or more flow meters also detects flow rates at appropriate points in the system and sends a signal to the input module.

In a third or high level system, multiple sensing and control systems, for example two systems in parallel, offer redundancy and backup, i.e. a “failsafe” system. In addition to the various components in the intermediate level system described above, a transfer switch controls use of the two systems such that only one system is in use at one time. Cables or similar means connect the transfer switch to comparator modules, which receive signals from pressure safety high and low devices; pressure and temperature transmitters, etc. This system uses multiple sensing devices for each aspect being measured. The use of “2 out of 3” logic permits a high degree of confidence in measured values, and permits repair/replacement of one sensing device while the remaining two sensing devices remain in service.

### BRIEF DESCRIPTION OF THE DRAWINGS

FIG. 1 is a diagram of the various sensing and control electrical components of an eductor recovery system with a first level control system.

FIG. 2 is diagram of the mechanical and other components of the first level system of FIG. 1.

FIG. 3 is a diagram of the various sensing and control electrical components of an eductor recovery system with a second or intermediate level control system.

FIG. 4 is a diagram of the mechanical and other components of the second level system of FIG. 3.

FIG. 5 is a diagram of the various sensing and control electrical components of an eductor recovery system with a third or high level control system, with redundant or “failsafe” elements.

FIG. 6 is a diagram of the mechanical and other components of the third level system of FIG. 5.

### DESCRIPTION OF THE PRESENTLY PREFERRED EMBODIMENT(S)

The invention may be described with reference to three possible levels of control: a first or lower level system; a second or intermediate level system; and a third or high level system. It is understood that the following description is of several presently preferred embodiments, and is made by way of example only and not limitation. Other embodiments are possible and contemplated within the scope of the invention.

### First Level System

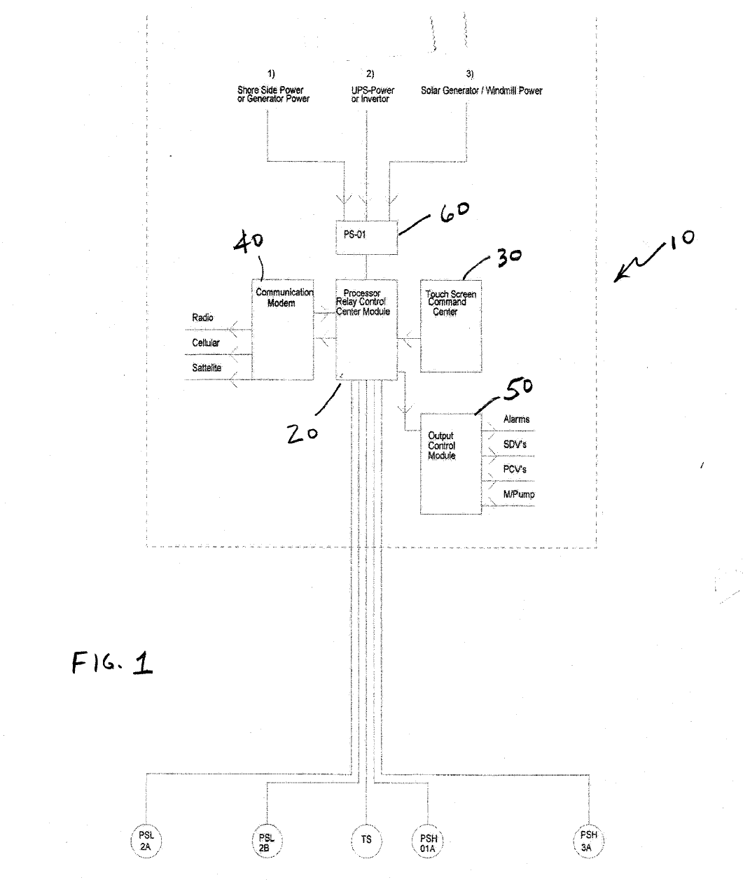

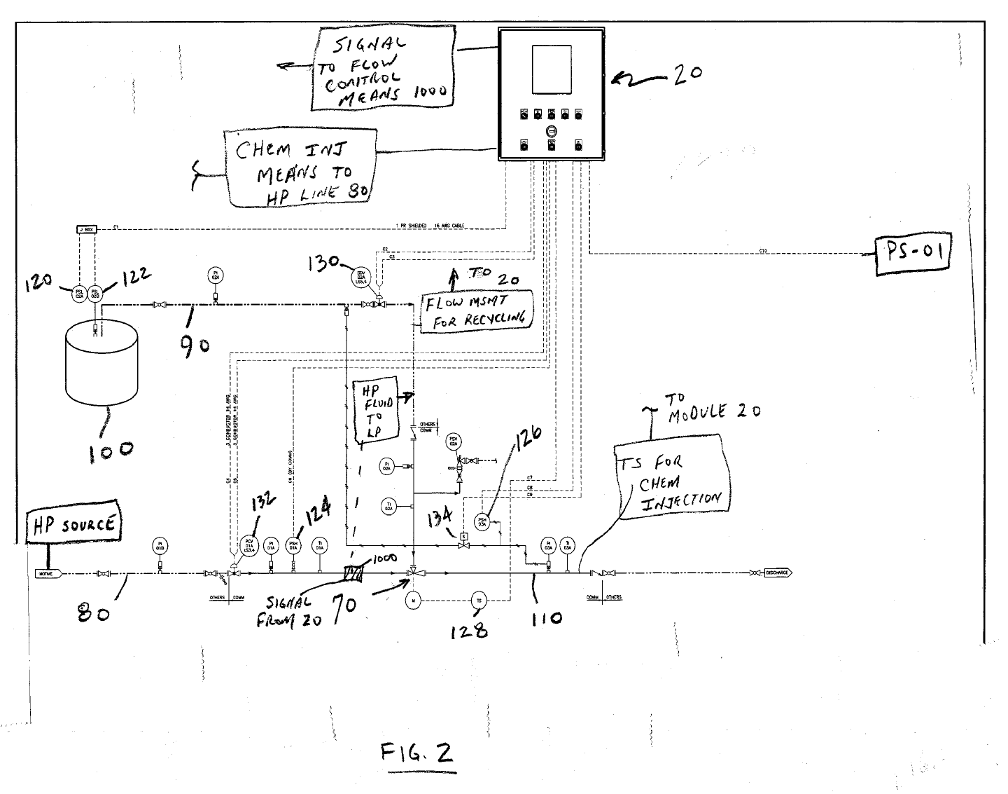

With reference to FIGS. 1 and 2, a first level eductor control system can be described. Referring first to FIG. 1, the eductor control system 10 comprises a processor relay control center module 20, which may be referred to as module 20, which receives data from various devices and sends appropriate control signals to control devices. Typically, module 20 comprises a number of switches or relays, which emit on/off signals to various control devices in response to input from sensing devices; such relay modules are known in the relevant art. Module 20 is powered by a power supply 60, which as shown may comprise shore side power, generator power, a battery/inverter, solar or wind generated power, or some combination thereof. A touch screen command device 30, or similar means, provides a way for an operator to enter appropriate instructions to module 20. A communication modem 40 permits communication to/from module 20, via one or more of radio, cellular, and/or satellite means, as shown.

Fundamentally, module 20 receives signals from various sensing devices, such as pressure safety low (labeled as “PSL 2A” and “PSL 2B”), pressure safety high (labeled as “PSH 01A” and “PSH 3A”) and temperature switch (labeled as “TS”) devices. Based on the sensing device signals, as compared to some control value, control signals are sent via output control module 50, to operate alarms, shut down valves (“SDVs”), pressure control valves (“PCVs”0, pumps and other devices.

FIG. 2 is a mechanical diagram of the first level system 10 of FIG. 1. An eductor 70 receives high pressure fluids, which may be liquids or gases, via a line or conduit 80 from a suitable source, which may be from the discharge of a compressor, pump, output of a well, etc. Eductors, in general, are commercially available, and sizing and specification for same are known in the art. Eductor 70 also receives low pressure fluids, which may be vapors and other fluids from any source, via a line or conduit 90, which may emanate from a hydrocarbon storage tank 100 or other similar source. The scope of the present invention encompasses low pressure fluids from any source. As previously described, under the operating principles of a venturi the passage of the high pressure fluids through the venturi results in a pressure drop, bringing in and combining the lower pressure fluids with the higher pressure fluids and resulting in an intermediate pressure fluid exiting the eductor via line or conduit 110, which can be put into a sales line or other desired and/or beneficial location.

Module 20 receives signals from several input sources, including but not limited to pressure safety low sensors 120 and 122, pressure safety high sensors 124 and 126, and temperature sensor 128. Appropriate programming is in place in module 20 for module 20 to send control signals to various control devices, including but not limited to shutdown valve 130, pressure control valve 132, and valve 134, in response to the various input signals, in order to optimize operation of the system. It is understood that the system may include other components known in the art for safe operation of systems of this type, including check valves, pressure and temperature indicators, etc.

### Intermediate Level System

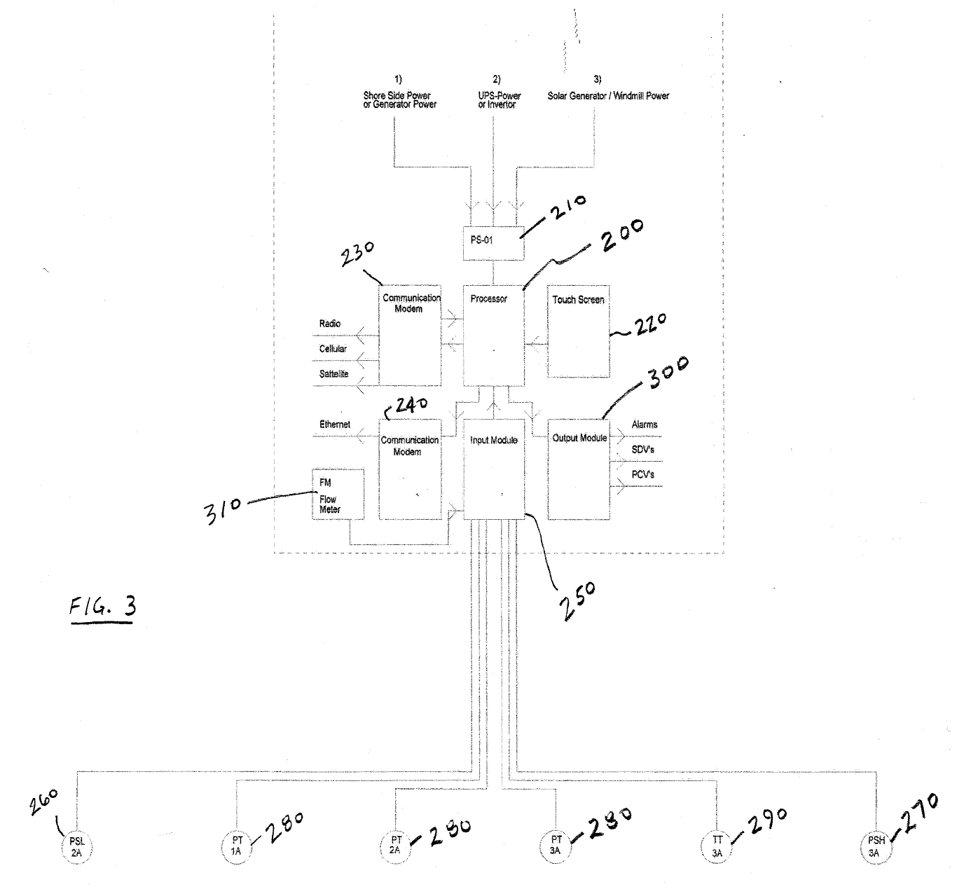

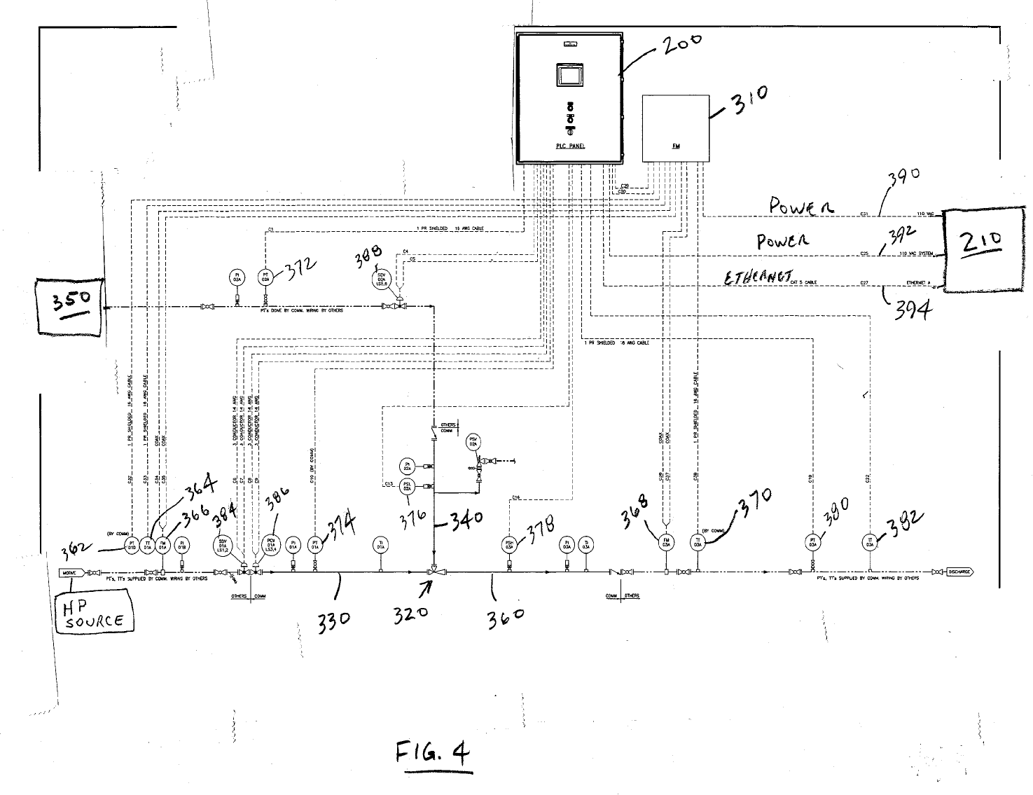

FIGS. 3 and 4 disclose the electrical and mechanical schematics for an exemplary intermediate level system. Looking first at FIG. 3, a programmable logic controller 200 is preferably used in lieu of the module 20 of the first level system. Programmable logic controller 200, referred to at times as PLC 200, is preferably a microprocessor having the capability to receive input signals from a various of sources, typically a greater number and of more complexity than the first level system previous described. The processor speed, memory capabilities, etc. of PLC 200 are as needed to effectively receive and process the number of input signals in question, and may be sized and otherwise specified as known in the relevant art. PLC 200 is powered by a power supply 210, which as shown may comprise shore side power, generator power, a battery/inverter, solar or wind generated power, or some combination thereof. A touch screen command device 220, or similar means, provides a way for an operator to enter appropriate instructions to PLC 200. A first communication modem 230 permits communication to/from PLC 200, via one or more of radio, cellular, and/or satellite means, as shown. The system preferably also comprises a second communication modem 240, which communicates via a high-speed connection, such as an ethernet connection. As is well known in the art, an ethernet connection permits very high speed transmission of large data sets.

PLC 200 must receive and process input signals from various signal devices. Generally, an input module is needed in order to properly “translate” those input signals into signals which the microprocessor can use. Input modules may be either internal to the microprocessor or external input modules. In the disclosed embodiment, external input modules are shown (which represent benefits in retrofitting of systems, in that if needed the input module may be separately changed out), however it is understood that the scope of the invention encompasses both internal and external input modules.

Input module 250 receives input signals from a variety of signal device sources, and transmits those signals to PLC 200. Exemplary signal devices include pressure safety low 260 (shown as “PSL 2A”), pressure safety high 270 (shown as “PSH 3A”), one or more pressure transmitters 280 (shown as PT 1A, PT 2A, and PT 3A), temperature transmitter 290 (shown as TT 3A). Input module 250 additionally receives input from flow meter 310. Based on the sensing device signals, as compared to some control value, control signals are sent via output module 300, to operate alarms, shut down valves (“SDVs”), pressure control valves (“PCVs”), pumps and other devices.

FIG. 4 is a mechanical diagram of the intermediate level system. As in the lower level system previously described, an eductor 320 receives high pressure fluids via a line or conduit 330 from a suitable source, which may be from the discharge of a compressor, a well, etc. Eductor 320 also receives low pressure vapors and other fluids via a line or conduit 340, which may emanate from a hydrocarbon storage tank or other similar low pressure fluid source 350. As previously described, operation of eductor 320 results in an intermediate pressure fluid exiting the eductor via line or conduit 360, which can be put into a sales line or other beneficial location.

A number of sensing and control devices feed into flow meter 310 and/or PLC 200, to enable efficient control of the system. In the illustrated embodiment, devices providing input to flow meter 310 include:
pressure transmitter 362, temperature transmitter 364, and flow meter 366, all on the high pressure line upstream of eductor 320;
flow meter 368 and temperature transmitter 370, on the intermediate line 360, downstream of eductor 320.
   Flow meter 310 in turn communicates with PLC 200.

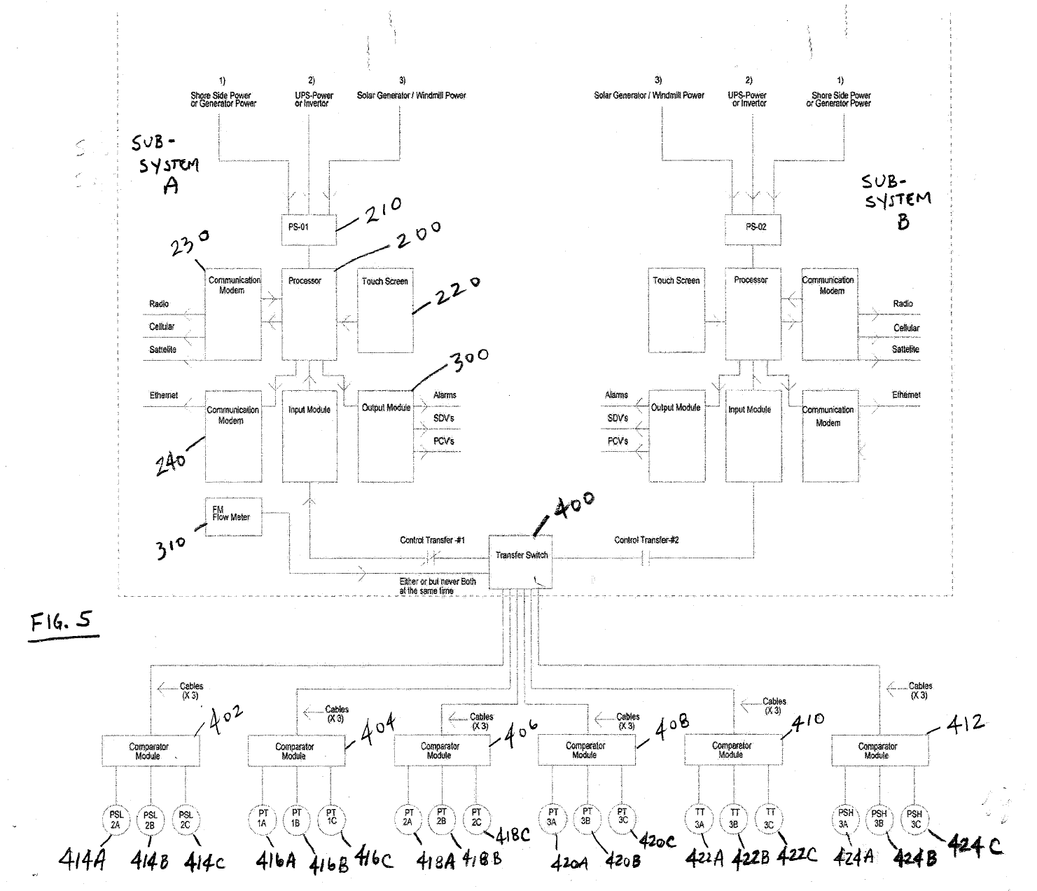

PLC 200 receives input from a variety of sources, including but not limited to flow meter 310 as described, and additionally from pressure transmitters 372, 374, and 380; pressure safety low 376 and pressure safety high 378, and temperature transmitter 382. In turn, PLC 200 sends output (control) signals to shut down valve 384 and pressure control valve 386, both of which control flow on the high pressure line 330 upstream of eductor 320; and to shut down valve 388 on low pressure line 340. It is understood that other pressure and flow sensors, and flow control devices, may be installed in the system and tied to either flow meter 310 and/or PLC 200. As can be further seen in FIG. 5, power cables 390 and 392 provide power to flow meter 310 and PLC 200, respectively, from one or more of the power sources previously described, namely power supply 210. An ethernet cable 394 provides high speed communication with PLC 200. It is understood that the system may include other components known in the art for safe operation of systems of this type, including check valves, pressure and temperature indicators, etc.

### High Level System

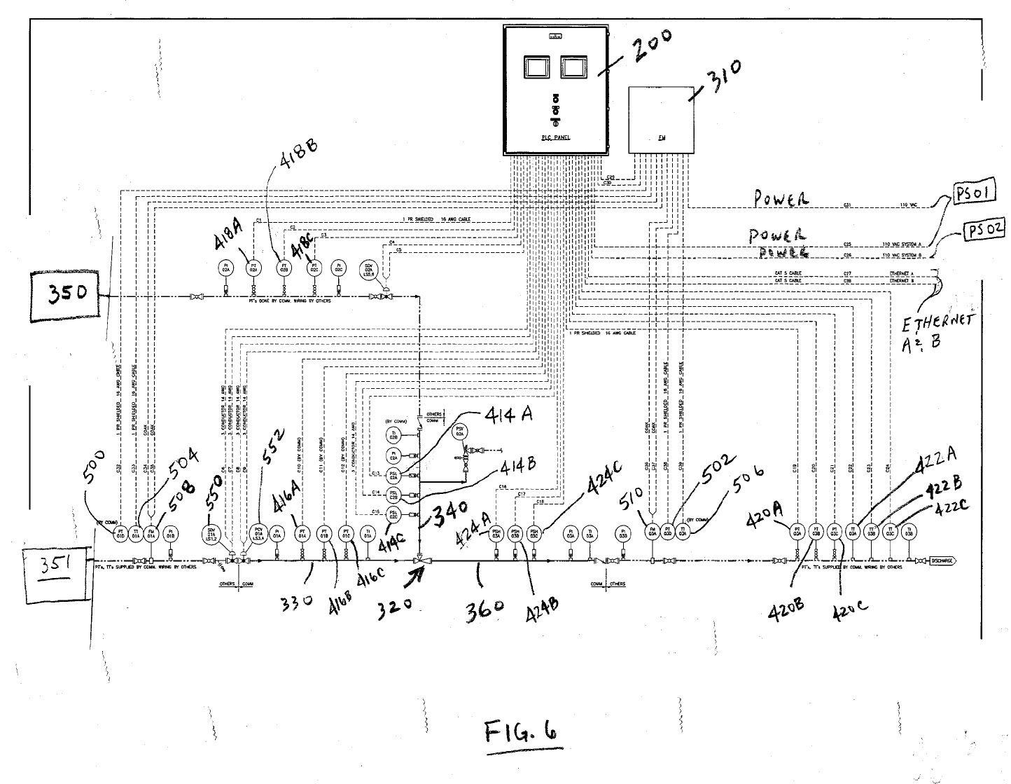

FIGS. 5 and 6 are electrical and mechanical system drawings of the high or third level system previously described. The high level system may be beneficially described as having a number of components in common with the intermediate system previously described. The differences between the two lie in a redundant control system (PLC, input module, etc.), and in a transfer switch which can transfer control of the overall system to either of the two control systems in the event of a failure or other event. The transfer switch in turn receives signals from a plurality of comparator modules, which receive signals from various pressure and temperature sensing devices as further described herein.

Referring to FIG. 5, the high level system comprises redundant sub-systems A and B, with various components as described with respect to the intermediate level system (FIG. 3). The same element numbers are used in FIG. 5, as were used in FIG. 3, figure for simplicity.

FIG. 5 further shows a transfer switch 400, which can transfer control of the overall system between sub-systems A and B as required. Transfer switch 400 is an electronic switch known in the relevant art. As seen in FIG. 5, a plurality of comparator modules receive data from input devices and send data to transfer switch, as follows:
comparator module 402, receiving signals from pressure safety low devices 414A, 414B, and 414C;
comparator module 404, receiving signals from pressure transmitters 416A, 416B, and 416C;
comparator module 406, receiving signals from pressure transmitters 418A, 418B, and 418C;
comparator module 408, receiving signals from pressure transmitters 420A, 420B, and 420C;
comparator module 410, receiving signals from temperature transmitters 422A, 422B, and 422C; and
comparator module 412, receiving signals from pressure safety high devices 424A, 424B, and 424C.

Comparator modules 402, 404, 406, 408, 410 and 412 each comprise an electronic means capable of comparing multiple input signals, to send appropriate signals to control devices.

Several aspects of the comparator system provide redundancy and yield a “failsafe” system. As can be seen on FIG. 5, multiple, preferably three each, sensing devices feed to each comparator. Each sensing device preferably takes readings from separate “taps”or sample points in the appropriate flow system being sensed; that is, the multiple sensing devices preferably do not simply take multiple readings from a single point or “tap.” Signals from the comparators run on multiple cables, in the illustrated embodiment three different cables corresponding to the number of sensing devices. The comparator modules operate on a “2 out of 3” basis, where an appropriate signal is transmitted which corresponds to the two sensors which are in agreement (in the event of disagreement between sensor readings). This permits a check on the validity of the readings; in addition, having three sensing devices permits repair or replacement of one of the three sensing devices, while the remaining two sensing devices remain in service and the overall system remains in service. This attribute decreases downtime of the system.

FIG. 6 is a schematic showing an exemplary mechanical layout of the higher level system. Mechanical elements are labeled so as to correspond with the electrical schematic of FIG. 5, and to large extent are numbered to correspond with like elements in FIG. 4. Eductor 320 receives low pressure fluid via line 340, which is supplied by a low pressure fluid source 350. Eductor 320 also receives high pressure fluid via line 330, from a high pressure source. As previously described, the combined fluid stream exits eductor 320 into an intermediate pressure line 360. As depicted, PLC 200, which comprises sub-systems A and B, receives power from power supplies PS01 and PS02. Further, PLC 200, via comparator modules 402, 404, 406, 408, 410, and 412 (not shown in FIG. 6), and via transfer switch 400 (not shown in FIG. 6), receives input signals from:
pressure safety low devices 414A, 414B, and 414C, on the low pressure fluid line;
pressure transmitter devices 416A, 416B, and 416C, on the high pressure fluid line;
pressure transmitter devices 418A, 418B, and 418C, on the low pressure fluid line;
pressure transmitter devices 420A, 420B, and 420C, on the intermediate pressure fluid line;
temperature transmitter devices 422A, 422B, and 422C, on the intermediate pressure fluid line; and
pressure safety high devices 424A, 424B, and 424C, on the intermediate pressure fluid line.

Shut down valve 550 and pressure control valve 552 may also be in place and operatively connected to PLC 200.

It is to be understood that other pressure, temperature, and flow devices may be in place as needed or desired in a particular setting.

Flow meter 310 receives signals from one or more flow meter, pressure transmitter, and temperature transmitter devices, for example pressure transmitters 500 on the high pressure fluid line and 502 on the intermediate pressure fluid line; temperature transmitters 504 on the high pressure fluid line and 506 on the intermediate pressure fluid line; and flow meters 508 on the high pressure fluid line and 510 on the intermediate pressure fluid line.

It will be understood by those having skill in the relevant art that the disclosed systems may comprise such further sensing devices, for pressure, temperature, flow, etc., and flow control and shutdown devices (valves) as are needed and appropriate for proper operation of the system. It will be further understood that appropriate computer programming is in place to enable the various components to communicate with one another and relay appropriate signals and commands.

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof. For example, the systems can be used in connection with low pressure fluid recovery in a variety of fields, including but not limited to hydrocarbon vapor/low pressure gas recovery. High pressure fluids may be liquids or gas, from a variety of sources, including but not limited to high pressure output from a compressor or pump, or flow from a well. The intermediate pressure receiving system may be a pipeline at appropriate pressure, including a natural gas sales pipeline; or may be a well at suitable pressure. The number and type of sensing devices may be changed as appropriate. Microprocessors with appropriate programming may be in place as needed.

Another attribute of the present invention may comprise appropriate chemical injection, by way of example methanol injection to combat hydrates in natural gas streams, which can result in ice-up of fluid lines. Chemical injection may be added to any of the three disclosed embodiments (first, second, or third level systems); by way of example, referring to FIG. 2, a temperature sensor on the intermediate pressure line (labeled TS FOR CHEMICAL INJECTION) sends a signal to module 20 (or in other embodiments, PLC 200), which in turn signals a chemical injection means (such as a pump or similar device) to inject chemical preferably into the high pressure line 80, upstream of eductor 70 (labeled CHEM INJ MEANS TO HP LINE 80). It is understood that other types of chemicals, to address other conditions, may be used.

Still another attribute of the present invention may comprise apparatus and method for “cycling” of high pressure gas, in order to maintain proper low pressure gas volume. An example may be described as follows, again with reference to FIG. 2. Eductor 70 operates most efficiently with certain minimum low pressure fluid flow rate, by way of example low pressure gas flow rate fed via low pressure line 90. In the event that the low pressure gas flow rate drops below the defined minimum flow rate, a portion of gas from the high pressure line 80 is routed to the low pressure input to eductor 70, so as to maintain flow rate at or above some minimum low pressure gas flow rate. A flow meter is therefore in place on low pressure fluid line 90, sensing rate and sending a signal to module 20, or in other embodiments PLC 200 (on FIG. 2, represented by FLOW MSMT FOR RECYCLING); module 20 (or PLC 200) sends a signal to a flow control device 1000, which routes a determined volume of high pressure gas to the low pressure line.

Various other modifications and embodiments are possible within the scope of the invention. Therefore, the scope of the invention is to be determined not by the illustrative examples set forth above, but by the appended claims and their legal equivalents.

I claim:

1. An automated low pressure fluid recovery system, comprising:
an eductor operatively connected to a low pressure fluid line, a high pressure fluid line, and an intermediate pressure fluid line, whereby high pressure fluids pass through a venturi means within said eductor and draw low pressure fluids into a mixture, discharging into said intermediate pressure fluid line;
a relay control center module comprising a plurality of switches, said switches set to pre-determined values of pressure, flow, and/or temperature parameters within said system;
a power supply supplying electrical power to said relay control center module;
a communication modem operatively connected to said relay control center module;
one or more pressure and temperature sensing devices disposed in said low, high, and intermediate pressure lines, and operatively connected to said relay control center module;
an output control module operatively connected to said relay control center module and receiving signals therefrom,
whereby in response to signals received from said one or more pressure and temperature sensing devices, said relay control center module emits one or more signals to said output control module, which emits signals to devices disposed in said low, high, and intermediate pressure lines, for control of fluid flow through said lines.

2. The automated low pressure fluid recovery system of claim 1, further comprising a touch screen input device operatively connected to said relay control center module.

3. An automated low pressure fluid recovery system, comprising one or more sub-systems, a first sub-system comprising:
an eductor operatively connected to a low pressure fluid line, a high pressure fluid line, and an intermediate pressure fluid line, whereby high pressure fluids pass through a venturi means within said eductor and draw low pressure fluids into a mixture, discharging into said intermediate pressure fluid line;
a programmable logic controller comprising a microprocessor;
an input module operatively coupled to said programmable logic controller;
a power supply supplying electrical power to said programmable logic controller;
a communication modem operatively connected to said programmable logic controller;
one or more pressure, temperature, and/or flow sensing devices disposed in said low, high, and intermediate pressure lines, and operatively connected to said input module;
an output control module operatively connected to said programmable logic controller and receiving signals therefrom,
whereby said programmable logic controller, in accordance with programming therein and in response to signals received from said one or more pressure, temperature and/or flow sensing devices, emits one or more signals to said output control module, which emits signals to devices disposed in said low, high, and intermediate pressure lines, for control of fluid flow through said lines.

4. The system of claim 3, further comprising an ethernet communication line operatively coupled to said programmable logic controller.

5. The system of claim 3, further comprising:
a) a second sub-system, comprising:
a programmable logic controller comprising a microprocessor;
an input module operatively coupled to said programmable logic controller;
a power supply supplying electrical power to said programmable logic controller;
a communication modem operatively connected to said programmable logic controller;
one or more pressure, temperature, and/or flow sensing devices disposed in said low, high, and intermediate pressure lines, and operatively connected to said input module;
an output control module operatively connected to said programmable logic controller and receiving signals therefrom,
whereby said programmable logic controller, in accordance with programming therein and in response to signals received from said one or more pressure, temperature and/or flow sensing devices, emits one or more signals to said output control module, which emits signals to devices disposed in said low, high, and intermediate pressure lines, for control of fluid flow through said lines;
b) a transfer switch wherein control of said low pressure fluid recovery system may be transferred between said first and said second sub-systems;
c) a plurality of comparator modules, each of said comparator modules comprising a microprocessor, each of said comparator modules receiving pressure, temperature, and/or flow data from said system, wherein each of said categories of data is sensed by multiple sensing devices and relayed to said comparator modules, said comparator modules operatively connected to said transfer switch by multiple cables corresponding in number to the number of sensing devices, wherein by programming said comparator modules compare data from said multiple sensing devices for each category of data and signal said input module accordingly.

6. The system of claim 5, further comprising ethernet communication means operatively connected to said programmable logic controllers.

7. A method for operation of a low pressure fluid recovery system, comprising the steps of:
a) providing a low pressure fluid recovery system, comprising:
an eductor operatively connected to a low pressure fluid line, a high pressure fluid line, and an intermediate pressure fluid line, whereby high pressure fluids pass through a venturi means within said eductor and draw low pressure fluids into a mixture, discharging into said intermediate pressure fluid line;
a programmable logic controller comprising a microprocessor;
an input module operatively coupled to said programmable logic controller;
a power supply supplying electrical power to said programmable logic controller;
a communication modem operatively connected to said programmable logic controller;
one or more pressure, temperature, and/or flow sensing devices disposed in said low, high, and intermediate pressure lines, and operatively connected to said input module;
an output control module operatively connected to said programmable logic controller and receiving signals therefrom,
a plurality of comparator modules, each of said comparator modules comprising a microprocessor, each of said comparator modules receiving pressure, temperature, and/or flow data from said system, wherein each of said categories of data is sensed by multiple sensing devices and relayed to said comparator modules, said comparator modules operatively connected to said input module by multiple cables corresponding in number to the number of sensing devices;
b) sensing pressure at a point within one of said fluid lines via three pressure sensing devices, each of said pressure sensing devices having an independent inlet into said fluid line;
c) sending pressure data from step (b) to one of said comparator modules, which emits instructions based on agreement between said three pressure sensing devices;
d) sending pressure data from said comparator module to said input module, and then to said programmable logic controller;
e) repeating steps (b)-(d) for temperature data;
f) adjusting fluid flow through said system by instructions from said programmable logic controller to flow control devices within said system, based on said pressure and temperature data.

8. The method of claim 7, wherein:
said low pressure fluid recovery system further comprises one or more fluid flow meters disposed in said system, and
wherein said method comprises repeating steps (b)-(d) for fluid flow data, and adjusting fluid flow through said system by instructions from said programmable logic controller to flow control devices within said system, based on said pressure, temperature, and fluid flow data.
